(19) United States
(12) Patent Application Publication
(10) Pub. No.: US 2020/0341200 A1
(43) Pub. Date: Oct. 29, 2020

(54) MULTI-LAYER GRATING COUPLER

(71) Applicant: Hewlett Packard Enterprise Development LP, Houston, TX (US)

(72) Inventors: Thomas Van Vaerenbergh, Palo Alto, CA (US); Peng Sun, Palo Alto, CA (US); Sagi Varghese Mathai, Palo Alto, CA (US)

(21) Appl. No.: 16/397,689

(22) Filed: Apr. 29, 2019

(51) Int. Cl. G02B 6/34; G02B 6/122

(52) U.S. Cl. CPC G02B 6/34; G02B 2006/12107; G02B 6/1228

(57) ABSTRACT

Examples herein relate to multi-layer grating couplers. In particular, implementations herein relate to multi-layer grating couplers that include a first grating layer, an angle correction layer disposed over the first grating layer, and an oxide layer disposed between the first grating layer and the angle correction layer. The multi-layer grating coupler further includes a waveguide layer disposed at a same elevation as or below the first grating layer. The first grating layer is configured to convert a propagation direction of light from an in-plane direction through the waveguide layer to a near-vertical or non-in-plane direction into the angle correction layer. The angle correction layer is configured to tilt an output coupling angle of the light from the first grating layer such that the light exits the multi-layer grating coupler into an optical fiber at a same angle as the optical fiber.

### STATEMENT OF GOVERNMENT RIGHTS

This invention was made with Government support under Agreement Number H98230-19-3-0002. The Government has certain rights in the invention.

### BACKGROUND

Optoelectronic communication (e.g., using optical signals to transmit electronic data) is becoming more prevalent as a potential solution, at least in part, to the ever increasing demand for high bandwidth, high quality, and low power consumption data transfer in applications such as high performance computing systems, large capacity data storage servers, and network devices. Gratings are components commonly used to manipulate light propagation in integrated photonics systems and devices. For example, gratings may be used in grating couplers, in reflectors such as distributed Bragg reflectors (DBRs), or as filters, waveguides, or lenses.

### BRIEF DESCRIPTION OF THE DRAWINGS

Certain examples are described in the following detailed description and in reference to the drawings, in which:

FIG. 1A schematically illustrates an example of a multi-layer grating coupler with an angle correction layer coupling light from a waveguide of to an optical fiber according to the present disclosure;

FIG. 1B schematically illustrates an example of a multi-layer grating coupler with an angle correction layer coupling light from an optical fiber to a waveguide according to the present disclosure;

FIG. 1C schematically illustrates another example of a multi-layer grating coupler with an angle correction layer coupling light from a waveguide of to an optical fiber according to the present disclosure; and

FIG. 2 schematically illustrates an example of an optical system including a multi-layer grating coupler and optical fiber according to the present disclosure.

### DETAILED DESCRIPTION OF SPECIFIC EXAMPLES

Gratings are a fundamental optical component particularly useful for semiconductor photonic integration. For example, grating couplers can be used to couple light into or out of a planar silicon photonics waveguide from or into a vertical or near-vertical optical fiber, respectively. However, they are sensitive to fabrication accuracy in various parameters, such as material thickness, grating etch depth, grating period, or alignment. Gratings are equally sensitive to environmental change, e.g., temperature fluctuations. Fabrication inaccuracies and temperature change may result in problems with various system parameters, such as coupling efficiencies/coefficients, optical bandwidth, or wavelength (e.g., Bragg grating wavelength).

Generally, there is a trade-off between overall coupling efficiency, reflection back into the waveguide, and the angle of an off-chip optical fiber in grating coupler designs (e.g., difficulty in optimizing for small input/output angles while maintaining low reflection and high overall coupling efficiency). While adding additional in-plane reflectors in front and back of a grating coupler to reduce reflection or providing dual etch designs may improve efficiency, this may lead to additional or more complex fabrication steps. In some designs, Bragg gratings as mirrors on-chip are used to couple light from the grating coupler to a vertical off-chip optical fiber. Such designs may have efficiency issues. Typically, grating couplers with bi-layer designs include layers positioned directly adjacent (e.g., with no space there between) or near each other (e.g., less than 200 nm apart) such that a single mode of light propagates through the combined layer stack. In such designs, the combination of grating coupler layers is optimized or used together to couple light out under a same angle from a planar waveguide to a near-vertical fiber (e.g., the layers are optically dependent layers). As such, tighter or more accurate alignment tolerances between the respective grating coupler layers may be required. Further, off-chip techniques (e.g., lenses and mirrors) employed to correct or tilt light or a ferrule holding the optical fiber may result in more complex or cumbersome assembly or manufacturing steps in order to integrate such additional components within an optical package.

The present disclosure describes examples of multi-layer grating couplers that include one or more first grating layers and one or more angle correction layers optically independent of each other as described in more detail below. The multi-layer grating couplers can optically couple light into a planar waveguide from a vertical or near-vertical off-chip optical fiber or out of a planar waveguide into a vertical or near-vertical off-chip optical fiber. In some implementations, the one or more angle correction layers are one or more second grating layers spaced apart from the one or more first grating layers (e.g., by an oxide layer) at a distance or height such that the layers are optically independent of each other. In other implementations, the one or more angle correction layers can include a prism etched into a layer of the multi-layer grating coupler disposed over (e.g., above) the one or more first grating layers.

As described herein, when coupling light out of the planar waveguide and into the optical fiber, the one or more first grating layers convert or are configured to convert a propagation direction of the light propagating through the planar waveguide from an in-plane direction (e.g., horizontal) to a near-vertical direction exiting the one of more first grating layers. In other implementations, the one or more first grating layers convert or are configured to convert a propagation direction of the light propagating through the planar waveguide from an in-plane direction (e.g., horizontal) to a non-horizontal or less near-vertical direction exiting the one of more first grating layers as described herein. The one or more angle correction layers then tilt or are configured to tilt the light exiting from the one or more first grating layers to a target angle (e.g., same angle as the optical fiber) to couple the light out of the multi-layer grating coupler and into the optical fiber. In other implementations, when coupling light into the planar waveguide from the optical fiber, the one or more angle correction layers tilt the light exiting the optical fiber and entering the multi-layer grating coupler from a vertical or angle the optical fiber is disposed at to a near-vertical angle after propagating through the angle correction layer. The one or more first grating layers are configured to convert or convert a propagation direction of the light from a near-vertical direction from the angle correction layer to an in-plane direction propagating through the waveguide layer. In yet other implementations, when coupling light into the planar waveguide from the optical fiber, the one or more angle correction layers tilt the light exiting the optical fiber and entering the multi-layer grating coupler from a vertical or angle the optical fiber is disposed at to a non-horizontal or less near-vertical angle after propagating through the angle correction layer. The one or more first grating layers are configured to convert or convert a propagation direction of the light from the non-horizontal or less near-vertical direction from the angle correction layer to an in-plane direction propagating through the waveguide layer.

Functionality of the angle correction layers and the first grating layers are decoupled such that the layers are optically independent of each other (e.g., the first grating layers do not impact an exit angle of the light from the multi-layer grating coupler to the optical fiber and the angle correction layers do not impact the conversion of the light from in-plane to near-vertical direction). As such, this may allow for optimization of the angle correction layers independent of the one or more first grating layers or vice versa. For example, the angle correction layers can be optimized to obtain more broad-band behavior. Additionally, alignment tolerance or accuracy between the angle correction layers and first grating layers may be reduced due to the decoupling of such layers. This may lead to reduced cost, improved performance (e.g., reducing coupling loss and improving yield and alignment accuracy) or improved manufacturability or design flexibility (e.g., with respect to the angle correction layers, first grating layers, or grating coupler as a whole).

An “optical fiber” as described herein can refer to a single optical fiber (e.g., including a core and a cladding) to provide unidirectional or bidirectional optical communication, can refer to a bidirectional pair of optical fibers (e.g., each including a core and a cladding) to provide both transmit and receive communications in an optical network, or can refer to a multi-core fiber, such that a single cladding could encapsulate a plurality of single-mode cores. As used herein, when a first layer is disposed “over” a second layer, then the first layer may be directly contacting the second layer or there may be one or more intervening layers between the first and second layers. If a first layer is “on” a second layer, then the first layer is directly contacting the second layer or there is a bonding material layer between the first and second layers.

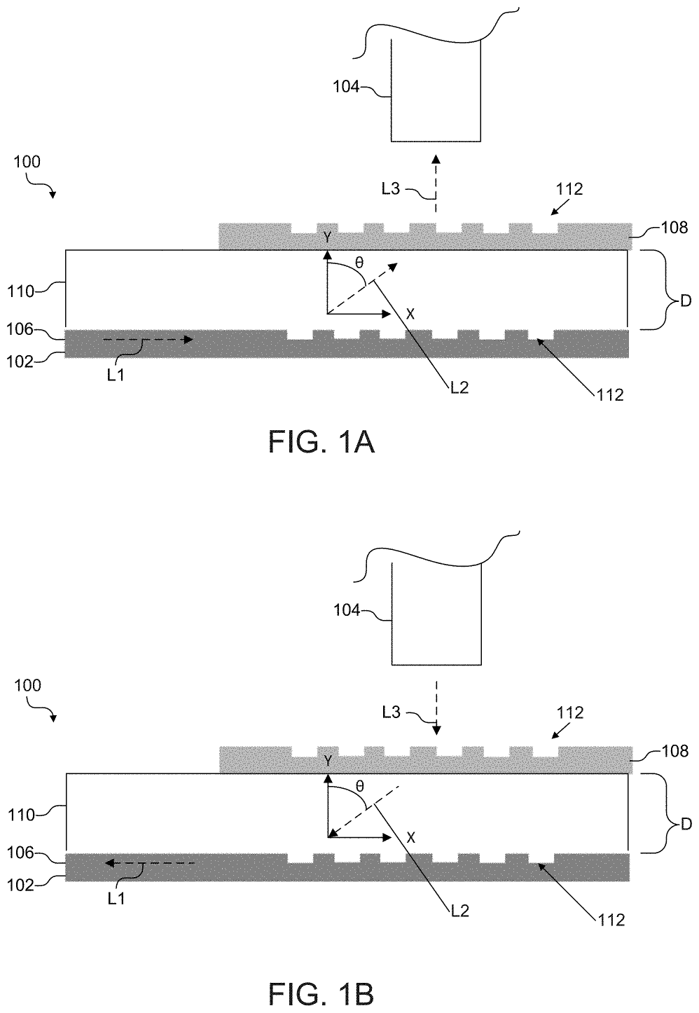

FIGS. 1A-1C illustrate an example of a multi-layer grating coupler 100 and components thereof according to the present disclosure. The multi-layer grating coupler 100 is configured to couple light (identified by broken leader line L) from a planar waveguide layer 102 into an optical fiber 104 (FIGS. 1A and 1C) or from the planar waveguide layer 102 into the optical fiber 104 (FIG. 1B). The multi-layer grating coupler 100 can be a 1D or a 2D grating coupler. The multi-layer grating coupler 100 includes a first grating layer 106 and an angle correction layer 108 disposed over (e.g., above) the first grating layer 106. An oxide layer 110 (e.g., silicon dioxide) is disposed between the first grating layer 106 and the angle correction layer 108. The planar waveguide layer 102 can be disposed at a same elevation or height as the first grating layer 106 or below the first grating layer 106.

While certain examples and figures herein refer specifically to coupling light into or out of an optical fiber (e.g., the multi-layer grating coupler 100 being configured to couple light from a planar waveguide layer 102 into an optical fiber 104 or from the planar waveguide layer 102 into the optical fiber 104), the multi-layer grating coupler 100 can be configured to couple light into or out of optical connectors, optical components of such optical connectors, as well as integrated photonics chips (e.g., stacks of silicon photonic chips). For example, the multi-layer grating coupler 100 can be configured to couple light into or out of an on- or off-chip lens, mirror, prism, or ferrule of an optical connector. Further, while referring to coupling light into or out of optical connectors, fibers, or other components, the multi-layer grating coupler 100 (e.g., the angle correction layer 108) can in addition or instead be configured to collimate or focus light incoming or exiting the multi-layer grating coupler 100 (e.g., from or to the optical fiber 104). In some implementations, this may eliminate the need for a collimating lens or mirror.

In some implementations, the first grating layer 106 is configured to convert or converts a propagation direction of the light from an in-plane direction identified as L1 (e.g., parallel or substantially parallel to a horizontal or X-axis) through the planar waveguide layer 102 to a near-vertical direction identified as L2 (e.g., at an angle θ relative to a vertical or Y-axis) into the angle correction layer 108. The angle θ (e.g., output coupling angle from the first grating layer 106) can be for example, ±1, ±2, ±4, ±8, or ±12 degrees, or any value there between (e.g., from ±1 to ±8, ±2 to ±7, ±3 to ±6). In other implementations, the first grating layer 106 is configured to convert or converts a propagation direction of the light from an in-plane direction identified as L1 (e.g., parallel or substantially parallel to a horizontal or X-axis) through the planar waveguide layer 102 to a non-horizontal or less near-vertical direction identified as L2 (e.g., at an angle θ relative to a vertical or Y-axis) into the angle correction layer 108. In such implementations, the angle θ (e.g., output coupling angle from the first grating layer 106) can be for example, ±15, ±20, ±25, ±30, ±35, ±40, ±45, or ±50, or any value there between (e.g., from ±15 to ±45, ±20 to ±40, ±24 to ±34).

The angle correction layer 108 is configured to tilt or tilts (e.g., corrects) the output coupling angle of the light from the first grating layer 106 such that the light (identified as L3) exits the multi-layer grating coupler 100 into an optical fiber 104 at a target angle. The target angle is the angle at which the optical fiber 104 is disposed, positioned, or extends relative to the planar waveguide layer 102. In the illustrated examples, the optical fiber 104 is disposed at a vertical angle (e.g., parallel or substantially parallel to the Y-axis). In other words, the optical fiber 104 is disposed or extends at zero or about zero degrees relative to the Y-axis (e.g., extends orthogonal relative to the planar waveguide layer 102). The angle correction layer 108 tilts the output angle of the light from the near-vertical (or non-horizontal) direction exiting the first grating layer 106 to the target angle for coupling into the optical fiber 104. In other implementations, the optical fiber 104 is disposed at five or eight degrees relative to the Y-axis and the angle correction layer 108 tilts the output angle to such a corresponding target angle.

As discussed above, the first grating layer 106 and the angle correction layer 108 are decoupled such that they are optically independent (e.g., their functionalities can be optimized independently of each other). The first grating layer 106 can thus be optimized for efficiency and reduce reflection. Conversely, the angle correction layer 108 can be optimized for correcting the output coupling angle of the first grating layer 106 to the target angle. By separating the functionality of the first grating layer 106 and the angle correction layer 108, the grating coupler 100 can be optimized for small or vertical input/output angles while maintaining low reflection and high overall coupling efficiency relative to current designs. Additionally, by providing more freedom or less restrictive angles (e.g., configured or optimized such that theta is near-vertical or non-horizontal) for the output or exit angle from the first grating layer 106, reflection can be reduced.

In some examples, the first grating layer 106 and the angle correction layer 108 are spaced apart at a distance D sufficient to decouple the angle correction layer 108 from the first grating layer 106 such that the first grating layer 106 does not impact the exit or target angle and/or a mode profile of the light. The first grating layer 106 and the angle correction layer 108 can be spaced apart by greater than or equal to about 200 nm, 220 nm, 240 nm, 260 nm, 280 nm, 300 nm, or any value there between. Such distances can allow the functionality of the first grating layer 106 and angle correction layer 108 to be decoupled. The distance D between the first grating layer 106 and the angle correction layer 108 is sufficient to prevent evanescent coupling of optical signals between the layers or such that there is substantially no evanescent coupling (e.g., less than 1%). Further, in some implementations, as opposed to conventional gratings, the spacing between etched grating structures (as described in more detail below) is not optimized in such manner for the purpose of reducing overall reflection of light propagating from the waveguide to the grating. As discussed above, the first grating layer 106 and angle correction layer 108 can be spaced apart by the oxide layer 110 disposed there between.

While illustrated with a single first grating layer 106, the multi-layer grating coupler 100 can include two or more first grating layers 106 (e.g., two, three, four, or more) under the angle correction layer 108. The two or more first grating layers 106 can be in direct contact with each other or spaced apart by an oxide layer. Such spacing between respective grating layers 106 can be optimized to allow evanescent coupling between such layers or reduce in-plane reflections in the waveguide to grating layer. In some examples, the multi-layer grating coupler 100 can include two or more angle correction layers 108 (e.g., two, three, four, or more) disposed over the one or more first grating layers 106. As discussed above, the angle correction layer(s) 108 can be two or more second grating layers disposed over the first grating layer(s). The two or more angle correction layers 108 can be in direct contact with each other or spaced apart by an oxide layer. In other examples, the angle correction layer(s) can include one or more prisms etched into the multi-layer grating coupler 100 above the first grating layer(s) 106.

Each of the first grating layers 106 or the angle correction layers 108 (e.g., when the angle correction layers include one or more second grating layers) can have etched grating structures 112. The grating structures 112 may be periodic or non-periodic (e.g., for apodization of the layer). Each of the first grating layers 106 or the angle correction layers 108 may be dual or double etched. Period (e.g., up to or equal to 0.5 microns), lengths, depths or widths (e.g., perpendicular to the paper the Figures are drawn on) of the etched grating structures 112 may be optimized for each of the respective layers for separate functionalities as described above. For example, in some implementations, the first grating layers have etched grating structures with etch depths of up to or equal to 50% of the layer depth or thickness (e.g., 5% to 50%, 15% to 35%, 20% to 30%). In some implementations, the angle correction layers have etched grating structures with etch depths of up to or equal to 100% of the layer depth or thickness (e.g., through-hole or completely etched). For example, (e.g., 50% to 100%, 60% to 90%, 70% to 80%). In some implementations, the width of the grating structures can be up to or equal to about 13 microns. As illustrated in FIG. 1C, in some examples, the angle correction layers 108 can include fully etched grating structures 112 (e.g., through-holes or cavities). In other examples, the first grating layers 106 can include fully etched grating structures 112. In yet other examples, both the first grating layers 106 and the angle correction layers 108 can include fully etched grating structures 112. In some examples, each of the layers 106 and 108 can include a combination of fully etched and partially etched grating structures. The grating structures 112 of the first grating layers 106 and the angle correction layers 108 may be aligned, misaligned, or have both aligned and misaligned portions relative to each other. Similarly, the grating structures 112 of each respective first grating layer 106 when the first grating layer 106 includes two or more grating layers may be aligned, misaligned, or have both aligned and misaligned portions relative to each other. The grating structures 112 of each respective angle correction layer 108 when the angle correction layer includes two or more grating layers may also be aligned, misaligned, or have both aligned and misaligned portions relative to each other.

Each of the first grating layers 106 or the angle correction layers 108 can be formed or composed of the same or different materials. Additionally, each of the respective first grating layers 106 when including two or more first grating layers 106 or the respective angle correction layers 108 when including two or more angle correction layers 108 can be formed or composed of the same or different materials. Example materials of the first grating layers 106 or angle correction layers 108 include, but are not limited to, silicon nitride crystalline silicon, or a combination of such materials. In some examples, the angle correction layers 108 are formed of silicon nitride while the first grating layers 106 are formed of crystalline silicon.

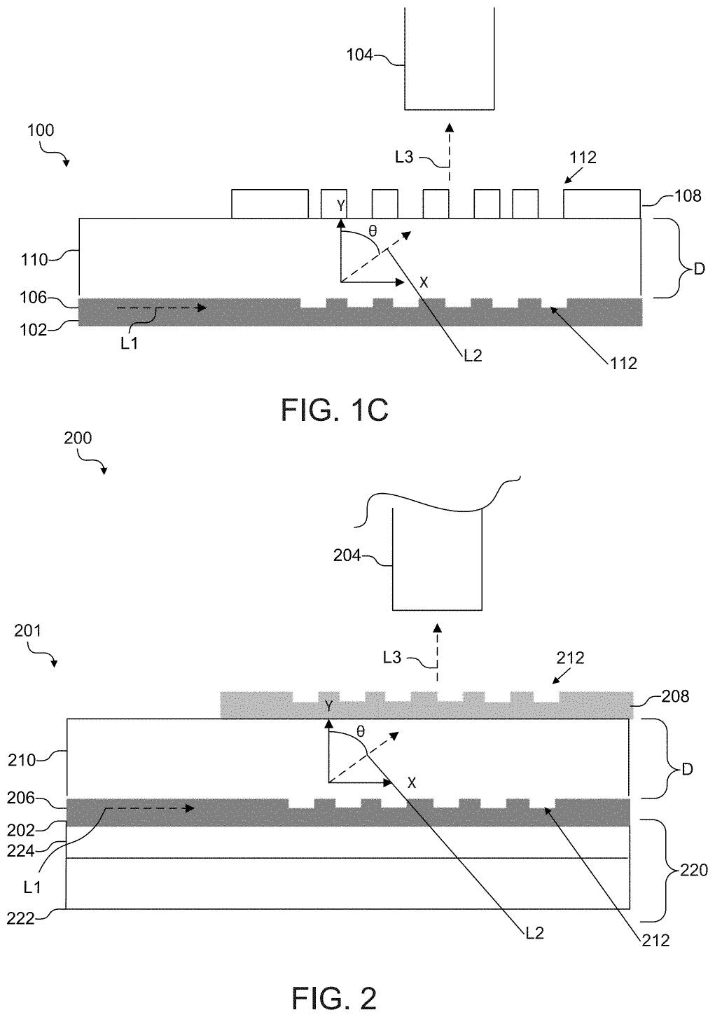

FIG. 2 schematically illustrates an optical system 200 including an optical fiber 204 and multi-layer grating coupler 201. The multi-layer grating coupler 201 may include any of the features or elements, in whole or in part, of the multi-layer grating coupler 100 as described above. The optical system 200 may be a chip or other semiconductor photonic integrated device or circuit. The optical system 200 may further include one or more optical sources (e.g., on-chip or off-chip) to emit light signals or photodetectors to receive/convert light signals to electrical signals. While illustrated as coupling light from the multi-layer grating coupler 201 to the optical fiber 204, the optical system 200 may also couple light from the optical fiber 204 to the multi-layer grating coupler 201.

As illustrated, the optical system 200 includes a semiconductor on insulator substrate 220. For example, the substrate 220 may be a silicon-on-insulator (SOI) substrate. The substrate 200 may include a silicon or other suitable semiconductor substrate layer 222 and an insulating layer 224 disposed over or formed on the substrate layer 222. The insulating layer 224 may be a buried oxide (BOX) layer and may be composed of silicon dioxide or another suitable insulating oxide material.

The multi-layer grating coupler 201 includes a planar waveguide layer 202 and first grating layer 206 disposed over the insulating layer 222. The waveguide layer 202 may be a same height or elevation as the first grating layer 206 or disposed below the first grating layer 206. The waveguide layer 202 may be composed of the same semiconductor material as the first grating layer 206. The multi-layer grating coupler 201 further includes an angle correction layer 208 disposed over the first grating layer 206. As described above, an oxide layer 210 may be disposed between the first grating layer 206 and the angle correction layer 208. As discussed above, the first grating layer 206 and the angle correction layer 208 are spaced apart sufficiently (e.g., at the distance D) such that their functionalities are decoupled and can be optimized independently of each other as described herein. For example, distance D is sufficient to prevent evanescent coupling or reduce it to a negligible amount where there is substantially no evanescent coupling (e.g., less than 1%). Further, each of the first grating layer 206 and the angle correction layer 208 can include etched grating structures 212.

Light from an optical source of the optical system 200 is propagated in an in-plane or otherwise horizontal direction (e.g., identified by L1) through the waveguide layer 202. The first grating layer 206 converts a propagation direction of the light from the in-plane direction through the waveguide layer 202 to a near-vertical direction (e.g., identified by L2) exiting the first grating layer 206 and into the angle correction layer 208. The angle correction layer 208 tilts an output coupling angle of the light from the first grating layer 206 such that the light (e.g., identified by L3) exits the multi-layer grating coupler 201 and is coupled to the optical fiber 204 at a zero degree angle relative to the vertical axis. In some examples, the multi-layer grating coupler 201 includes one or more cladding layers (e.g., disposed over the first grating layer 206 or the angle correction layer 208). In some examples, the multi-layer grating coupler 201 includes one or more reflector layers or mirrors (e.g., disposed below the BOX or insulating layer 224).

In some examples, the multi-layer grating couplers or optical systems as described herein, do not include or are constructed without one or more of the following components: off-chip lenses or mirrors employed to correct or tilt light prior to entering an optical fiber, a ferrule configured to hold the optical fiber at a non-vertical angle, or in-plane reflectors or mirrors in front or back of the grating coupler.

In the foregoing description, numerous details are set forth to provide an understanding of the subject disclosed herein. However, implementations may be practiced without some or all of these details. Other implementations may include additions, modifications, or variations from the details discussed above. It is intended that the appended claims cover such modifications and variations. The specification and drawings are, accordingly, to be regarded as illustrative rather than restrictive.

It will be recognized that the terms “comprising,” “including,” and “having,” as used herein, are specifically intended to be read as open-ended terms of art. The term “or,” in reference to a list of two or more items, covers all of the following interpretations of the word: any of the items in the list, all of the items in the list, and any combination of the items in the list. As used herein, the terms “connected,” “coupled,” or any variant thereof means any connection or coupling, either direct or indirect (e.g., having additional intervening components or elements), between two or more elements, nodes, or components; the coupling or connection between the elements can be physical, mechanical, logical, optical, electrical, or a combination thereof.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

1. A multi-layer grating coupler configured to couple light from a planar waveguide into an optical fiber, the multi-layer grating coupler comprising:
a first grating layer;
an angle correction layer disposed over the first grating layer;
an oxide layer disposed between the first grating layer and the angle correction layer; and
a waveguide layer disposed at a same elevation as or below the first grating layer, wherein the first grating layer is configured to convert a propagation direction of light from an in-plane direction through the waveguide layer to a non-in-plane direction into the angle correction layer, and wherein the angle correction layer is configured to tilt an output coupling angle of the light from the first grating layer such that the light exits the multi-layer grating coupler into an optical fiber at a same angle as the optical fiber.

2. The multi-layer grating coupler of claim 1, further comprising two or more first grating layers under the second grating layer.

3. The multi-layer grating coupler of claim 1, wherein the angle correction layer comprises one or more second grating layers disposed over the first grating layer.

4. The multi-layer grating coupler of claim 1, wherein the angle correction layer comprises a prism.

5. The multi-layer grating coupler of claim 1, wherein the first grating layer and the angle correction layer are spaced apart at a distance sufficient to decouple the angle correction layer from the first grating layer such that the first grating layer does not impact the output coupling angle of the light and/or a mode profile of the light.

6. The multi-layer grating coupler of claim 5, wherein the first grating layer and the angle correction layer are spaced apart such that there is substantially no evanescent coupling between the first grating layer and the angle correction layer.

7. The multi-layer grating coupler of claim 1, further comprising the optical fiber and wherein the optical fiber is disposed orthogonal to the waveguide layer.

8. A multi-layer grating coupler configured to couple light from an optical fiber into a planar waveguide, the multi-layer grating coupler comprising:
a first grating layer;
an angle correction layer disposed over the first grating layer;
an oxide layer disposed between the first grating layer and the angle correction layer; and
a waveguide layer disposed at a same elevation as or below the first grating layer, wherein the angle correction layer is configured to tilt an input coupling angle of light entering the multi-layer grating coupler from an optical fiber from a vertical angle to a non-vertical angle after propagating through the angle correction layer, and wherein the first grating layer is configured to convert a propagation direction of the light from a near-vertical direction from the angle correction layer to an in-plane direction through the waveguide layer.

9. The multi-layer grating coupler of claim 1, further comprising two or more first grating layers under the second grating layer.

10. The multi-layer grating coupler of claim 1, wherein the angle correction layer comprises one or more second grating layers disposed over the first grating layer.

11. The multi-layer grating coupler of claim 1, wherein the angle correction layer comprises a prism.

12. The multi-layer grating coupler of claim 1, wherein the first grating layer and the angle correction layer are spaced apart at a distance sufficient to decouple the angle correction layer from the first grating layer such that the first grating layer does not impact tilting of the input coupling angle of the light entering the multi-layer grating coupler by the angle correction layer and/or a mode profile of the light.

13. The multi-layer grating coupler of claim 5, wherein the first grating layer and the angle correction layer are spaced apart such that there is substantially no evanescent coupling between the first grating layer and the angle correction layer.

14. The multi-layer grating coupler of claim 1, further comprising the optical fiber and wherein the optical fiber is disposed orthogonal to the waveguide layer.

15. An optical system comprising:
an optical connector extending parallel to a vertical axis; and
a photonic integrated circuit comprising a multi-layer grating coupler, the multi-layer grating coupler comprising:
a first grating layer;
an angle correction layer disposed over the first grating layer;
an oxide layer disposed between the first grating layer and the angle correction layer; and
a waveguide layer disposed at a same elevation as or below the first grating layer, wherein the first grating layer is configured to convert a propagation direction of light from an in-plane direction through the waveguide layer to a non-in-plane direction into the angle correction layer, and wherein the angle correction layer is configured to tilt an output coupling angle of the light from the first grating layer such that the light exits the multi-layer grating coupler and is coupled to the optical connector at a zero degree angle relative to the vertical axis.

16. The optical system of claim 15, further comprising two or more first grating layers.

17. The optical system of claim 15, wherein the angle correction layer comprises one or more second grating layers disposed over the first grating layer.

18. The optical system of claim 15, wherein the multi-layer grating coupler comprises a buried oxide layer below the waveguide layer and a substrate layer below the buried oxide layer.

19. The optical system of claim 15, wherein the optical connector comprises at least one of an optical fiber, lens, mirror, prism, ferrule, or photonic chip.

20. The optical system of claim 15, wherein the multi-layer grating coupler comprises one or more reflector layers.
